(19) United States
(12) Patent Application Publication
(10) Pub. No.: US 2015/0040236 A1
(43) Pub. Date: Feb. 5, 2015

(54) ADDING RANDOMIZATION TO AUTOMATED PROCESS FLOWS

(71) Applicant: International Business Machines Corporation, Armonk, NY (US)

(72) Inventors: Mark Crosbie, Dublin (IR); Joseph Kevin Kiernan, Dublin (IR); Alex Markelov, Dublin (IR)

(21) Appl. No.: 13/958,098

(22) Filed: Aug. 2, 2013

(51) Int. Cl. G06F 21/60; G06Q 10/06

(52) U.S. Cl. CPC G06F 21/60; G06Q 10/06316
USPC 726/26

(57) ABSTRACT

A method, system and article of manufacture for adding randomness to a process used to achieve a specified objective. In one embodiment, the method comprises defining a multitude of solution paths through the process for achieving the specified objective; storing the paths as process workflows; and in response to a specified event, choosing one of the solution paths at random and executing the process, using the chosen solution path, to achieve the specified objective. In an embodiment, the process includes a specified number of steps; and the solution paths are defined by defining a multitude of orders of the steps, each of the orders, when executed, achieving the specified result. In one embodiment, at least a plurality of the steps includes one or more parameters; and a range of values is defined for at least one of the parameters of at least one of the steps.

### BACKGROUND

This invention generally relates to adding randomness to processes to avoid predictable behaviors.

It is often important or helpful to avoid predictable behavior because such behavior may allow an individual, who may be a competitor, an adversary, or have a malicious intent, to undermine, sabotage, or gain a competitive advantage over a particular system or process. Predictable behavior is, however, all too common.

In many situations, a competitor may gain an understanding of the business rules present in an automated process flow through, for instance, analysis of the reaction of a system to various inputs. For example, consider the case of a city coordination center dispatching cash-in-transit vans form a central depot. The vans must be staffed with crews, escorted by police and follow a prescribed route. It is possible for an individual to learn how each of these process steps are completed and hence plan to attack the transit vans through a weak-point in the process flow (e.g. block the intended route and force the convoy to unfamiliar territory).

Consider a similar problem in the military space. In defense operations, processes and solutions that are well defined and that follow a routine schedule and workflow to achieve a solution may be vulnerable as targets which can be monitored by enemies using surveillance techniques and then attacked.

For example, troop deployment, supply-chain management and allocation of support resources to combat troops are often done using automated processes. However, an enemy may be able to subvert or attack a system if the system exhibits predictable behavior in response to a given set of input conditions.

This problem is known as “traffic analysis” and occurs, for example, in military intelligence and network security.

### BRIEF SUMMARY

Embodiments of the invention provide a method, system of and article of manufacture for adding randomness to a specified process used to achieve a specified objective. In one embodiment, the method comprises defining a multitude of solution paths through the process for achieving the specified objective; storing said multitude of paths as process workflows; and at one or more selected times, choosing one of said solution paths at random and executing the process, using said chosen one of the solution paths, to achieve the specified objective.

In an embodiment of the invention, the process includes a specified number of steps; and the defining a multitude of solution paths includes defining a multitude of orders of the steps, each of said orders, when executed, achieving the specified objective.

In one embodiment, at least some of the steps are dependent on others of the steps; and the defining a multitude of solution paths includes analyzing the process to identify the ones of the steps that are dependent on others of the steps.

In one embodiment, the defining a multitude of solution paths includes generating a random order of the steps.

In an embodiment of the invention, the defining a multitude of solution paths includes analyzing the process to identify a plurality of the process steps that can be re-organized in a random order without affecting the specified objective of the process.

In an embodiment, the defining a multitude of solution paths includes a user selecting a subset of the steps for randomization.

In one embodiment, the process includes a multitude of steps, at least a plurality of the steps including one or more parameters; and the defining a multitude of solution paths includes defining a range of values for at least one of the parameters of at least one of the steps.

In one embodiment, the defining a multitude of solution paths includes generating a set of random values for said at least one of the parameters.

In an embodiment, the defining a multitude of solution paths includes ranking said multitude of solution paths using a defined procedure and based on defined similarities of the solution paths to each other.

In one embodiment, the process includes a multitude of parameters; and the defining a multitude of solution paths includes applying a randomization function to one or more of the parameters, and a user selecting an entropy and a distribution of said randomization function.

Embodiments of the invention add a degree of randomness to processes to thwart the ability of a person to profile the system to try to learn about internal aspects and features of the system.

Embodiments of the invention prevent an outsider, who may have competitive or malicious intent, from determining, for example, how a critical business process will operate when some degree of secrecy is required. As more business processes become automated, and as more critical infrastructure is run using these automated processes, it becomes critical to allow key processes to maintain a degree of unpredictability while still delivering their target result.

Embodiments of the invention use the feature of randomization within a set of desired outcomes to add a degree of uncertainty to business processes while at the same time ensuring that the overall objective of the system is met.

### BRIEF DESCRIPTION OF THE DRAWINGS

FIG. 1 illustrates a method embodying this invention.

FIG. 2 depicts in more detail an embodiment of the invention

FIG. 3 shows several steps, business rules, and various directed graphs that may be formed from those steps using those business rules.

FIG. 4 shows five steps arranged in a linear sequence.

FIG. 5 illustrates a computing environment in which embodiments of the invention may be practiced.

### DETAILED DESCRIPTION

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The present invention relates to avoiding predictable behavior by adding randomness to a process. As mentioned above, it is often important or helpful to avoid predictable behavior because such behavior may allow a person to subvert, attack, or better compete against a process or system.

Embodiments of the invention add a degree of randomness to processes to thwart the ability of a person to profile the system to try to learn about internal aspects and features of the system.

Embodiments of the invention prevent an outsider, who may have competitive or malicious intent, from determining, for example, how a critical business process will operate when some degree of secrecy is required. As more business processes become automated, and as more critical infrastructure is run using these automated processes, it becomes critical to allow key processes to maintain a degree of unpredictability while still delivering their target result.

Embodiments of the invention use randomization within a set of desired outcomes to add uncertainty to business processes while at the same time ensuring that the overall objective of the process is achieved.

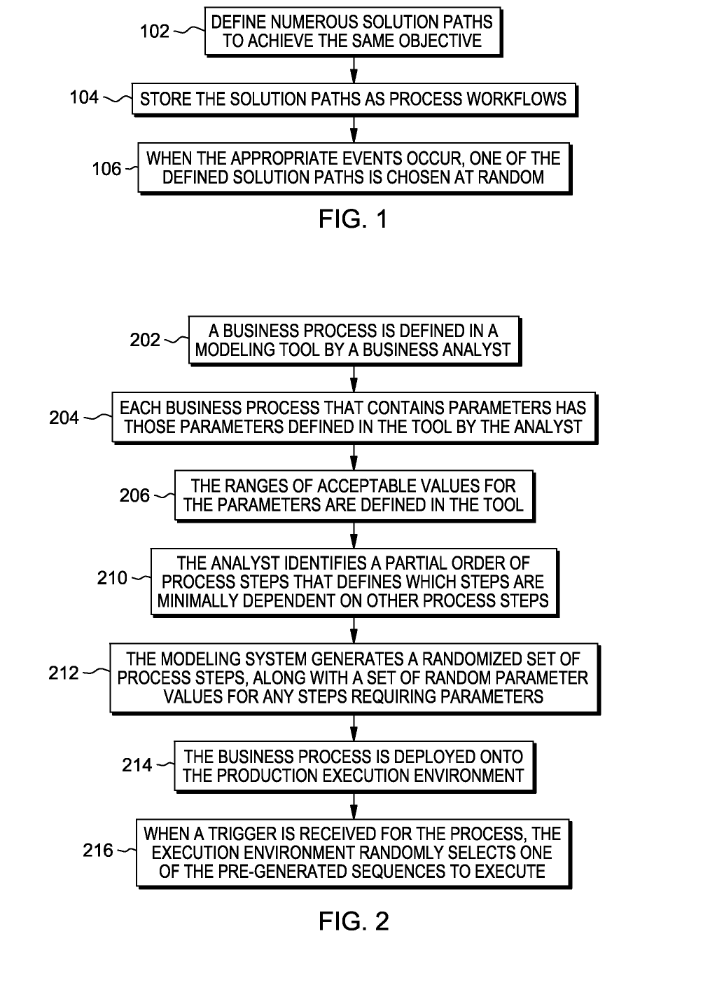

Embodiments of the invention use business analytic techniques to define numerous solution paths to achieve the same objective. With reference to FIG. 1, as represented at 102, these solution paths are stored as process workflows, and as represented at 104, when the appropriate events occur to trigger an automated process, one of the defined solution paths is chosen at random. This path may be chosen using, for instance, a built in random number generator on a host, which may be, for example, a computer system or processing unit.

FIG. 2 illustrates an embodiment of the invention in more detail. At 202, a business process is defined in a modeling tool by a business analyst. The business process is comprised of a series of process steps, with decision points at which as to which step is executed. At 204, each business process that contains parameters has those parameters defined in the tool by the analyst, and at 206, the range of acceptable values for the parameters are defined in the tool.

At 206, the analyst identifies a partial order of process steps that defines which steps are minimally dependent on other process steps. At 210, the modeling system generates a randomized set of process steps, along with a set of random parameter values for any steps requiring parameters. At 212, the business process is deployed onto the production execution environment. At run time, 214, when a trigger is received for the process, the execution environment randomly selects one of the pre-generated sequences to execute.

The execution environment could be, for example, a system using a cryptographically secure pseudo-random number generator to randomly select one of the predefined sequences which meets the business process rules. Taking the security van as an example the execution environment might randomly select which driver to use, which co-driver to use, which available van to select, which job to assign to the van, which time to execute a delivery/pick up. All are variables which have defined parameters which meet the business objectives but the sequence and values for certain actors are chosen randomly from a defined range.

A number of approaches can be used in this invention.

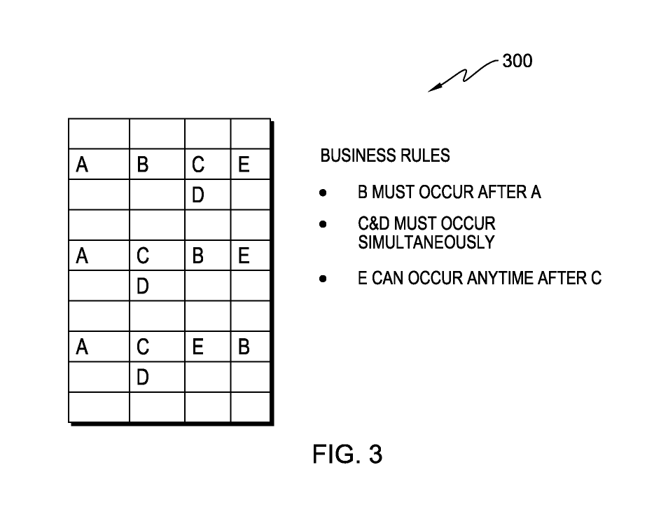

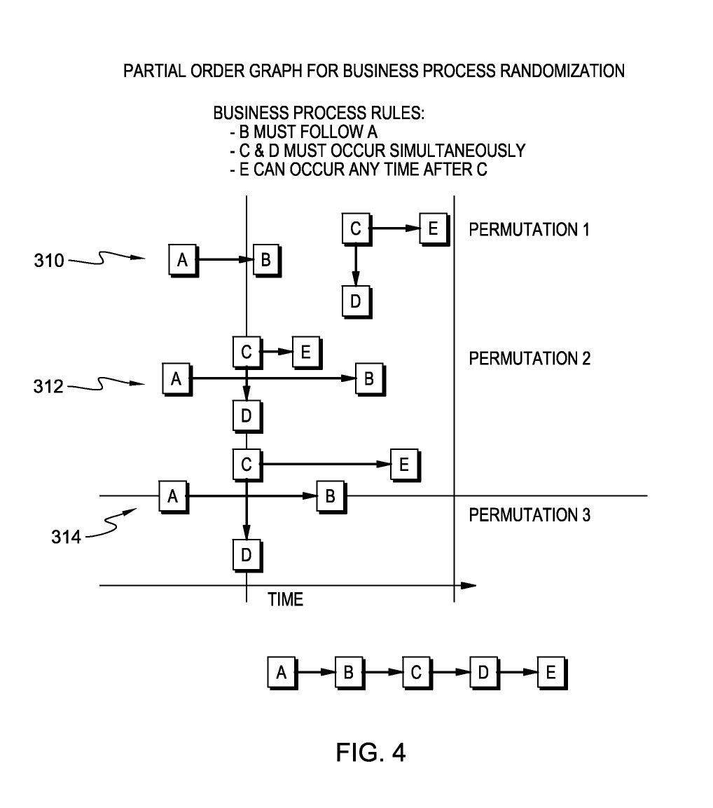

As one scenario, consider a business process comprised of a series of steps, which may be performed in a partial order. With reference to FIG. 3, in this scenario, as an example, a process is comprised of a series of steps A, B, C, D and E which are arranged by dependency into a partial-ordered graph. In this example, consider that B must follow A, that C and D must occur together, and that E can occur at any point after C. There are a number of possible permutations of ordering of these steps in the business process which can be selected at random to achieve the equivalent desired outcome.

As another scenario, consider a business process comprised of a series of steps each of which may be randomly varied. In this scenario a process is comprised of a set of steps A, B, C, D and E, where these steps must be performed in the fixed order A through E. In this scenario, each step has parameters that may be varied at random within defined limits, while preserving the fixed order of the steps. For example, consider the scheduling of a cash-in-transit van, where step A is the selection of the vehicle to use, step B is the assignment of a crew to the vehicle, and so forth. Within each step, there are parameters that can be adjusted within defined ranges to achieve unpredictability while preserving the fixed order of the steps.

Embodiments of the invention may include or use a number of features. For example, in an embodiment, a system or an analyst may analyze a business process to identify process steps that can be re-organized in random order without affecting the overall result of the process. In embodiments of the invention, a graph-based analysis of the process steps may be used to identify dependencies between steps such that unrelated steps can be re-arranged in the process, and a new process may be generated based on a re-arranged graph of the process steps. A user interface may be provided to allow a person to specify the parameters to randomize within a process and to further view the result of the randomization on the process.

Embodiments of the invention may rank randomized processes in terms of their similarity so that a user can elect the most suitable for the task at hand. A user may select a subset of the steps for randomization, and embodiments of the invention may randomize the parameters to a single business process. A user may be presented with an interface to allow a user to select parameters to a process step that is to be randomized A user may select the entropy and distribution of a randomization function applied to the parameters in a process step.

A wide range of computer or processing devices or systems may be used in or with the implementation of the present invention. For instance, computer workstation, personal computers, laptop computers may be used. Mobile devices such as handheld and table devices may also be used.

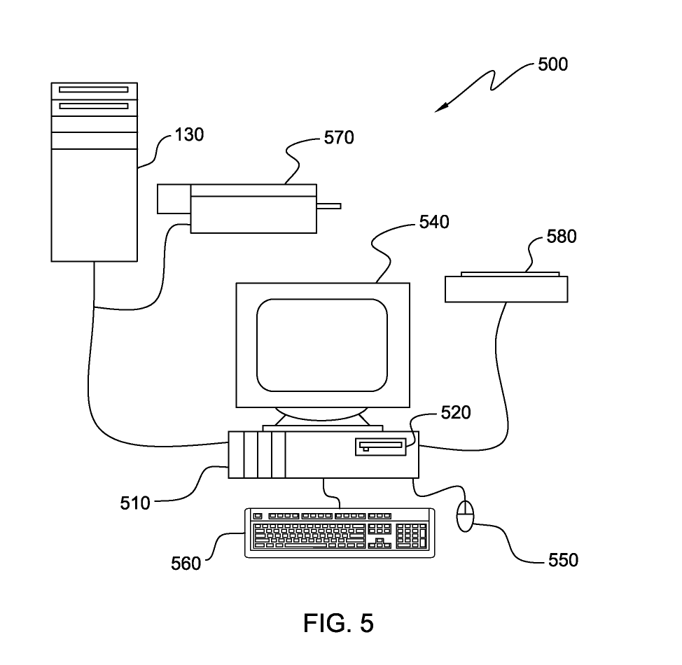

As one example, a computer-based system 100 in which embodiments of the invention may be carried out is depicted in FIG. 5. The computer-based system 100 includes a processing unit 110, which houses a processor, memory and other systems components (not shown expressly in the drawing) that implement a general purpose processing system, or computer that may execute a computer program product. The computer program product may comprise media, for example a compact storage medium such as a compact disc, which may be read by the processing unit 110 through a disc drive 120, or by any means known to the skilled artisan for providing the computer program product to the general purpose processing system for execution thereby.

The computer program product may comprise all the respective features enabling the implementation of the inventive method described herein, and which—when loaded in a computer system—is able to carry out the method. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit 110, as mentioned, or may be located on a remote system such as a server 130, coupled to processing unit 110, via a network interface such as an Ethernet interface. Monitor 140, mouse 150 and keyboard 160 are coupled to the processing unit 110, to provide user interaction. Scanner 180 and printer 170 are provided for document input and output. Printer 170 is shown coupled to the processing unit 110 via a network connection, but may be coupled directly to the processing unit. Scanner 180 is shown coupled to the processing unit 110 directly, but it should be understood that peripherals might be network coupled, or direct coupled without affecting the performance of the processing unit 110.

While it is apparent that the invention herein disclosed is well calculated to fulfill the objectives discussed above, it will be appreciated that numerous modifications and embodiments may be devised by those skilled in the art, and it is intended that the appended claims cover all such modifications and embodiments as fall within the true spirit and scope of the present invention.

1. A method of adding randomness to a specified process used to achieve a specified objective, the method comprising:
defining a multitude of solution paths through the process for achieving the specified objective;
storing said multitude of paths as process workflows; and
in response to a specified event, choosing one of said solution paths at random and executing the process, using said chosen one of the solution paths, to achieve the specified objective.

2. The method according to claim 1, wherein:
the process includes a specified number of steps; and
the defining a multitude of solution paths includes defining a multitude of orders of the steps, each of said orders, when executed, achieving the specified result.

3. The method according to claim 2, wherein:
at least some of the steps are dependent on others of the steps; and
the defining a multitude of solution paths includes analyzing the process to identify the ones of the steps that are dependent on others of the steps.

4. The method according to claim 2, wherein the defining a multitude of solution paths includes generating a random order of the steps.

5. The method according to claim 2, wherein the defining a multitude of solution paths includes analyzing the process to identify a plurality of the process steps that can be re-organized in a random order without affecting the specified objective of the process.

6. The method according to claim 2, wherein the defining a multitude of solution paths includes a user selecting a subset of the steps for randomization.

7. The method according to claim 1, wherein:
the process includes a multitude of steps, at least a plurality of the steps including one or more parameters; and
the defining a multitude of solution paths includes defining a range of values for at least one of the parameters of at least one of the steps.

8. The method according to claim 7, wherein the defining a multitude of solution paths includes generating a set of random values for said at least one of the parameters.

9. The method according to claim 1, wherein the defining a multitude of solution paths includes ranking said multitude of solution paths using a defined procedure and based on defined similarities of the solution paths to each other.

10. The method according to claim 1, wherein:
the process includes a multitude of parameters; and
the defining a multitude of solution paths includes
applying a randomization function to one or more of the parameters, and
a user selecting an entropy and a distribution of said randomization function.

11. A system for adding randomness to a specified process used to achieve a specified objective, the system comprising one or more processing units configured for:
defining a multitude of solution paths through the process for achieving the specified objective;
storing said multitude of paths as process workflows; and
in response to a specified event, choosing one of said solution paths at random and executing the process, using said chosen one of the solution paths, to achieve the specified objective.

12. The system according to claim 11, wherein:
the process includes a specified number of steps;
at least some of the steps are dependent on others of the steps; and
the defining a multitude of solution paths includes
defining a multitude of orders of the steps, each of said orders, when executed, achieving the specified objective, and
analyzing the process to identify the ones of the steps that are dependent on others of the steps.

13. The system according to claim 12, wherein the defining a multitude of solution paths includes:
analyzing the process to identify a plurality of the process steps that can be re-organized in a random order without affecting the specified objective of the process; and
generating a random order of the steps.

14. The system according to claim 11, wherein:
the process includes a multitude of steps, at least a plurality of the steps including one or more parameters; and
the defining a multitude of solution paths includes defining a range of values for at least one of the parameters of at least one of the steps.

15. The system according to claim 14, wherein the defining a multitude of solution paths includes:
generating a set of random values for said at least one of the parameters.
ranking said multitude of solution paths using a defined procedure and based on defined similarities of the solution paths to each other.
applying a randomization function to one or more of the parameters, and
a user selecting an entropy and a distribution of said randomization function.

16. An article of manufacture comprising:
at least one tangible computer readable storage device having computer readable program code logic tangibly embodied therein to add randomness to a specified process used to achieve a specified result, the computer readable program code logic, when executing in one or more processing units:
receiving input defining a multitude of solution paths through the process for achieving the specified objective;
storing said multitude of paths as process workflows; and
in response to a specified event, choosing one of said solution paths at random and executing the process, using said chosen one of the solution paths, to achieve the specified objective.

17. The article of manufacture according to claim 16, wherein:
the process includes a specified number of steps;
at least some of the steps are dependent on others of the steps; and
the multitude of solution paths includes a multitude of orders of the steps, each of said orders, when executed, achieving the specified result.

18. The article of manufacture according to claim 17 wherein the input:
identifies a plurality of the process steps that can be re-organized in a random order without affecting the specified objective of the process; and
a random order of the steps.

19. The article of manufacture according to claim 16, wherein:
the process includes a multitude of steps, at least a plurality of the steps including one or more parameters; and
the input identifies a range of values for at least one of the parameters of at least one of the steps.

20. The article of manufacture according to claim 19, wherein the input:
identifies a set of random values for said at least one of the parameters; and
ranks said multitude of solution paths using a defined procedure and based on defined similarities of the solution paths to each other;
applies a randomization function to one or more of the parameters; and
selects an entropy and a distribution of said randomization function.
